(19) United States
(12) Patent Application Publication
(10) Pub. No.: US 2022/0289160 A1
(43) Pub. Date: Sep. 15, 2022

(54) Systems and Methods for Calibrating a Braking System

(71) Applicant: Atlis Motor Vehicles, Inc., Mesa, AZ (US)

(72) Inventor: Mark Hanchett, Mesa, AZ (US)

(73) Assignee: Atlis Motor Vehicles, Inc., Mesa, AZ (US)

(21) Appl. No.: 17/831,520

(22) Filed: Jun. 3, 2022

Related U.S. Application Data
(60) Provisional application No. 63/215,014, filed on Jun. 25, 2021.

(51) Int. Cl. B60T 13/14; F16D 65/18; F16D 65/74

(52) U.S. Cl. CPC B60T 13/142; F16D 65/18; F16D 65/74; B60T 2270/88; B60T 2201/12; F16D 2066/003

(57) ABSTRACT

A braking system for a vehicle includes a processing circuit, a pad position detector, a pressure sensor, a pad positioner and a pressure combiner. The pressure sensor and the pad positioner are adapted to determine a thickness of a friction material of a pad of the braking system. The pad position detector is adapted to detect the position between the pad and a rotor of the braking system. The pad positioner and the pressure combiner are adapted to determine a desired position between the pad and the rotor to provide a desired braking response time and a desired amount of drag.

### BACKGROUND

Embodiments of the present invention relate to braking systems for vehicles.

Vehicle owners would benefit from a braking system that determines the wear on the pads the braking system and positions the pads for fast engagement while reducing drag.

### SUMMARY

An example embodiment of a braking system of the present disclosure uses pressure sensors and position detectors to determine the wear on a pad of the braking system and to position the pad so that the brakes engage quickly after the pedal is pressed and so that the pads do not increase drag on the vehicle when the brakes are not engaged.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is a diagram of an example embodiment of a braking system of the present disclosure.

FIG. 2 is a side view of a pad positioned at a first position relative to a rotor.

FIG. 3 is a side view of the pad positioned at a second position relative to the rotor.

FIG. 4 is a side view of the pad positioned at a third position relative to the rotor.

FIG. 5 is a side view of the pad positioned at a fourth position relative to the rotor.

FIG. 6 is a diagram of the positions of the pad relative to the rotor with respect to pressure.

FIG. 7 a diagram of pressure from the pressure combiner during braking and non-braking.

FIG. 8 a diagram of pressure from the master cylinder during braking and non-braking.

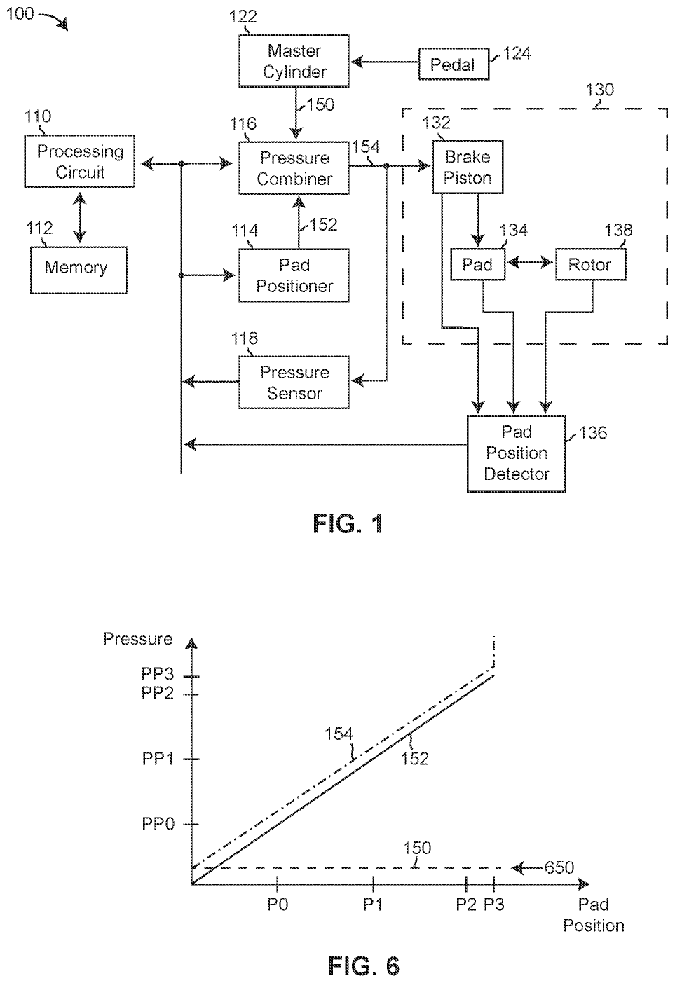

### DETAILED DESCRIPTION

### Overview

An example embodiment of the present disclosure relates to a braking system 100 for a vehicle, and in particular a braking system that uses disc brakes (e.g., 130). The example embodiment uses a pressure sensor 118 and a pad position detector 136 to determine wear on the pad 134, to position the pad 134 with respect to the rotor 138 for fast engagement when the brakes are asserted (e.g., activated, pedal pressed), and to position the pad 134 with respect to the rotor 138 when the brakes are not asserted (e.g., not activated, pedal not pressed) to reduce drag on the rotor 138.

Another example embodiment includes a pad positioner 114, a pressure sensor 118, and a pad position detector 136. The pad positioner 114 is adapted to increase or decrease the pressure of the brake fluid provided to the brake piston 132 to move the brake pad 134 toward or away from respectively the rotor 138. The pressure sensor 118 is adapted to detect the pressure of the brake fluid provided to the brake piston 132. The pressure sensor 118 is adapted to detect when the brake pad 134 is in contact with the rotor 138. The pressure sensor 118 is further adapted to detect the amount of force applied by the brake pad 134 on the rotor 138. The pad position detector 136 is adapted to detect the physical position of the pad 134 with respect to the rotor 138.

In an example embodiment, a vehicle braking system via the master cylinder 122 applies a certain amount of pressure via the brake fluid to engage the brakes. Engaging the brakes includes moving the pad 134 against the rotor 138 and pressing the pad 134 forcefully against the rotor 138. Generally, when the brakes are not being applied, the pad 134 is forced away from the rotor 138 by some type of a resilient force. The resilient force keeps the pad 134 away from the rotor 138 when the brakes are not applied to reduce the drag force applied by the pad 134 on the rotor 138 and therefore on the vehicle. However, if the pad 134 is held far away from the rotor 138, when the brakes are applied, the pad 134 must traverse the distance to the rotor before it can be pressed against the rotor 138 to apply the brakes. Moving the pad 134 across the distance lengthens the time between pressing the pedal 124 and applying the brakes. The resulting delay may be sufficient to be perceived by the driver.

An example embodiment uses the pad positioner 114 to position and maintain the brake pad 134 close to the rotor 138 when the brakes are not applied so that when the brakes are applied the time between pressing the pedal 124 and applying the brakes is reduced. The driver may perceive this reduced delay as being small so that the operation of the pedal and application of the brakes seems nearly instantaneous. The example embodiment further uses the pad positioner 114 to keep the brake pad 134, when the brakes are not applied, far enough away from the rotor 138 that the brake pad 134 does not drag on the rotor 138 and thereby increase the drag of the vehicle. Positioning the pad 134 close to the rotor 138 to improve brake response time yet keeping the pad 134 far enough away from the rotor 138 to reduce drag are conflicting goals. The example embodiment attempts to balance response time and drag.

The example embodiment further uses the pressure sensor 118 and the pad position detector 136 to determine the wear on the brake pad 134. Determining the wear on the brake pad 134 includes determining the thickness of the friction material 252 on the pad 134.

Master Cylinder and Pedal

In an example embodiment, the braking system 100 includes a pedal 124 and a master cylinder 122. The master cylinder 122 is adapted to convert a mechanical force on the pedal 124 to a pressure 150. In particular, the master cylinder 122 is adapted to provide a fluid (e.g., brake fluid) at the pressure 150. When the driver of the vehicle presses the pedal 124, the master cylinder 122 is adapted to provide brake fluid via the conduit 150 at the pressure 150. The harder the driver presses on the pedal 124, the higher the pressure 150 of the brake fluid provided by the master cylinder 122. When the driver is not pressing the pedal 124, the pressure 150 (e.g., magnitude) is a non-braking pressure 650. When the driver is pressing the pedal 124, the pressure 150 is a braking pressure, which is greater than the non-braking pressure 650 and varies proportionally to the force the driver applies to the pedal 124.

In an example embodiment, the brake fluid from the master cylinder 122 is provided to the pressure combiner 116 via the conduit 150. The pressure combiner 116 in turn provides breaking fluid to the brake piston 132 at the pressure 154. In another example embodiment, the master cylinder 122 does not provide brake fluid to pressure combiner 116, but merely reports the pressure 150 to the pressure combiner 116, which provides the brake fluid to the brake piston 132 at the pressure 154.

In another example embodiment, the pressure combiner 116, as discussed below in further detail, receives brake fluid from that master cylinder 122 at a first pressure (e.g., pressure 150) and brake fluid from the pad positioner 114 at a second pressure (e.g., pressure 152) and provides brake fluid to the brake piston 132 at a third pressure (e.g., pressure 154) that is the combination (e.g., addition, sum, sum*factor) of the first pressure (e.g., magnitude of the first pressure) and the second pressure (e.g., magnitude of the second pressure).

### Disc Brake

A disc brake 130, as referred to herein, includes the brake piston 132, at least one pad 134, and at least one rotor 138. Generally, the disc brake 130 includes at least two pads 134 Per rotor 138, one on each side of the rotor 138. The structure and operation of the present disclosure is described with respect to a single pad 134 and a single rotor 138; however, the concepts disclosed apply to two or more pads 134 and/or two or more rotors 138.

The components of the disc brake 130 are generally mounted on a caliper. The caliper is positioned around and on each side of a portion of the rotor 138. The caliper is adapted to position the pad 134 and the brake piston 132 with respect to the rotor 138. As discussed above, the example embodiments discussed herein describe a single pad 134 positioned on one side of the rotor 138. The pad 134 is adapted to contact the rotor 138 to slow the rotation of the rotor 138. In an embodiment of the disc brake 130 that includes two pads 134, one pad 134 is positioned on one side of the rotor while the other pad 134 is positioned on the other side of the rotor. When the brakes are applied, the pads 134 contact both sides the rotor 138 and squeeze the rotor 138 to slow the rotation of the rotor 138. The rotor 138 is connected to a wheel of the vehicle, so slowing the rotation of the rotor 138 slows the rotation of the wheel and thereby the velocity of the vehicle.

The brake piston 132 moves toward and away from the rotor 138 responsive to the pressure of the brake fluid provided to the brake piston 132. If the force provided by the brake piston 132, responsive to the pressure of the brake fluid, is less than the resilient force that moves the pad 134 away from the rotor 138, then the pad 134 moves away from the rotor 138. If the force provided by the brake piston 132, responsive to an increase in the pressure of the brake fluid, is greater than the resilient force then the pad 134 moves toward the rotor 138. During braking, the pressure of the brake fluid increases so that the force provided by the brake piston 132 increases to move the pad 134 into contact with rotor 138 to slow the rotation of the rotor 138. In an example embodiment, the brake piston 132 receives brake fluid from the pressure combiner 116.

The pad 134 presses a friction material 252 against the rotor 138 and through friction slows the rotations of the rotor 138. The friction material 252 rubs against the rotor 138. The contact between the friction material 252 and the rotor 138 wears away the friction material 252, so that in time the pad 134 must be replaced with a new pad 134. As the friction material 252 wears away, the distance between the pad 134 and the rotor 138 increases. So, as the friction material 252 wears away, the pad 134 must move a greater distance, when the pedal 124 is pressed, before the friction material 252 comes into contact with the rotor 138. Because it takes the pad 134 more time to traverse the increased distance, the time between pressing on (e.g., applying a force to) the pedal 124 and the application of the brakes increases. The increase in the time may affect the braking performance of the vehicle and may be noticeable to the driver.

The pad positioner 114, the pressure combiner 116, the pressure sensor 118 and the pad position detector 136 may cooperate to overcome the disadvantage of increased distance between the pad 134 and the rotor 138 due to wear of the friction material 252. Further, the pad positioner 114, the pressure sensor 118 and the pad position detector 136 may detect the thickness of the friction material 252 on the pad 134 to determine when the pad 134 need to be replaced.

### Pad Positioner Detector

The pad position detector 136 is adapted to detect the distance between the rotor 138 and the pad 134. The pad position detector 136 may detect the position between any portion of the rotor 138 and any portion of the pad 134. In an embodiment, the pad position detector 136 detects the distance between the backing plate 250 on the rear of the pad 134, behind the friction material 252, and the center 240 (e.g., center line 240) of the rotor 138. The distance from the backing plate 250 to the center 240 of the rotor 138 is referred to as the distance from the pad to the rotor center, which is abbreviated Dprc and identified as the distance Dprc 230. In another embodiment, the pad position detector 136 detects the distant from the backing plate 250 to the face 254 of the rotor 138. The distance from the backing plate 252 the face 254 is referred to as the distance from the pad to the rotor face, which is abbreviated Dprf and identified as the distance Dprf 220. In another embodiment, the pad position detector 136 detects the distance from the face 256 of the friction material 252 to the face 254 of the rotor 138. The distance from the face 256 of the friction material 252 to the face 254 of the rotor 132 is referred to as the distance from the pad face to the rotor face, which is abbreviated Dpfrf and is identified as the distance Dpfrf 260.

The pad position detector 136 alone may detect the distance between the pad 134 and the rotor 138. Further the pad position detector 136 alone may detect the distance between the face 256 of friction material 254 and the face 254 of the rotor 138 (e.g., Dpfrf). As the friction material 254 wears away, due to use, the pad position detector 136 may detect the increased distance between the face 256 of the friction material 252 and the face 254 of the rotor 138. The pad position detector 136 may also cooperate with the pressure sensor 118 and the pad positioner 114 to detect the distance between the pad 134 and the rotor 138.

The pad position detector 136 may use any technique for detecting the distance between any portion of the pad 134 and any portion of the rotor 138. In an example embodiment, the pad position detector 136 includes a light source and a light detector. The light source shines a light toward the gap between the face 256 and the face 254. The light detector detects the width of the gap (e.g., Dpfrf). In another example in embodiment, laser measurement techniques are used. In another example embodiment, pad position detector 136 uses mechanical devices to measure the distances. In another example embodiment, the pad position detector 136 detects the position of brake piston 132 to determine the position of the pad 134 relative to the rotor 138. In another example embodiment, the pad position detector 136 uses a combination of some or all of the techniques discussed above to determine the position of pad 134 with respect to the rotor 138.

### Pad Positioner and Pressure Combiner

The pad positioner 114 is adapted to position the pad 134 a distance away from the rotor 138. The pad positioner 114 provides brake fluid at a pressure that overcomes the resilient force that pushes the pad 134 away from the rotor 138. The pad positioner 114 positions the pad 134, in particular the friction material 252 of the pad 134, a distance away from the face 254 of the rotor 138. The pad positioner 114 provides brake fluid at a base pressure to position the pad 134 the distance away from the rotor 138. In an example embodiment, the pad positioner 114 positions the pad 134 so that the friction material 252 does not contact the rotor 138 while the brakes are not applied. While the brakes are not applied, the pad positioner 114 positions the pad 134 a small (e.g., 0.01 millimeters-5 millimeters) away from the rotor 138. Because the distance is small between the pad 134 the rotor 138, when the brakes are applied the friction material 252 quickly moves across the small distance to contact the rotor 138. Because the distance is small, the driver does not notice the time it takes for the pad 134 to traverse the distance as a delay in applying the brakes. In another example embodiment, pad positioner 114 positions the pad 134 so that the face 256 of the friction material 252 lightly touches the face 254 of the rotor 138, but does not apply pressure (e.g., barely touches).

Maintaining the pad 134 positioned a small distance away from the rotor 138 while the brakes are not applied makes the brakes more responsive to the pedal 124 when pressed because the pad 134 quickly traverses the distance between the pad 134 and the rotor 138 to come into contact with the rotor 138 to begin braking. Maintaining the friction material 252 positioned away from the rotor 138, even though the distance be small, reduces drag of the pad 134 on the rotor 138 because the friction material 252 barely touches or does not touch the rotor 138. If the face 254 of the rotor 138 is not flat or the rotor 138 is positioned at a slight angle with respect to the pad 134, the friction material 252 may contact the rotor 138 during part of a revolution of the rotor 138, but not during the remainder of the revolution. The distance between the pad 134 and the rotor 138 may be increased to eliminate all contact while the brakes are not applied to compensate for irregularities in the pad 138 and/or the rotor 138. In another example embodiment, the pad 134 may be positioned to provide a small amount of contract with portions of the rotor 138 as the rotor 138 rotates to maintain an overall small distance between the pad 134 and the rotor 138. There is a tradeoff between drag and braking responsiveness by maintaining a small distance between the pad 134 and the rotor 138.

In an example embodiment, the pad positioner 114 provides brake fluid via conduit 152 to the pressure combiner 116. The pressure of the brake fluid in the conduit 152 is referred to as the pressure 152. In another example embodiment, the pad positioner 114 does not provide brake fluid to pressure combiner 116, but merely reports the pressure 152 to the pressure combiner 116, which provides the brake fluid to the brake piston 132 at pressure 154.

### Pressure Combiner

The pressure combiner 116 is adapted to cooperate with the pad positioner 114 and the master cylinder 122 to position the pad 134 relative to the rotor 138. The pressure combiner 116 positions the pad 134 while the brakes are applied and while the brakes are not applied. In an example embodiment, the pressure combiner 116 detects the pressure 150 from the master cylinder 122, detects the pressure 152 from the pad positioner 114 and determines the pressure 154 by adding the pressure 150 to the pressure 152 to get a sum, referred to herein as pressure 154. The pressure 154 is reported to the brake piston 132 for positioning the pad 134. The pressure 154 may be reported to the brake piston 132 by providing breaking fluid to the brake piston 132 at the pressure 154.

In another example embodiment, the pressure combiner 116 detects pressure 150 and the pressure 152. The pressure combiner 116 determines the pressure 154 by adding the pressure 150 and the pressure 152 then multiplying the sum by a factor. The factor may be greater than or less than one to increase or decrease respectively the sum. In an example embodiment, the factor is in the range of 0.8 to 1.2. The factor may be used to increase or decrease the pressure 154 by an amount which in turn decreases or increases the distance between the pad 134 and the rotor 138.

In another example embodiment, the pressure combiner 116 adjusts the pressure 150 from the master cylinder 122 so that the pressure 150 when the brakes are not applied, non-braking pressure 650, is represented as zero pressure to the depression combiner 116. In other words, the pressure combiner 116 adjusts the pressure 150 downward by the amount of non-braking pressure 650 prior to combining it with the pressure 152. In this example embodiment, the pressure 150 is adjusted to represent only the pressure responsive to pressing the pedal 124 while the pressure 152 represents the pressure needed to move the pad 134 turn acceptable position with respect to the rotor 138.

In an example embodiment, the pressure combiner 116 receives brake fluid from the master cylinder 122 via the conduit 150 and at the first pressure 150. The pressure combiner 116 receives additional brake fluid from the pad positioner 114 via the conduit 152 at the second pressure 152. The pressure combiner combines the brake fluid received via the conduit 150 and the brake fluid received via the conduit 152 and provides brake fluid to the brake piston 132 via conduit 154 for at the third pressure 154. In an example embodiment, the third pressure 154 is the sum of the pressure 150 and the pressure 152. In another example embodiment, the third pressure 154 is the sum of the pressure 150 and the pressure 152 multiplied by a factor. In another example embodiment, the third pressure 154 is the sum of the pressure 150 after being adjusted for the non-braking pressure 650 and the pressure 152. In another example embodiment, the third pressure 154 is the sum of the adjusted pressure 150 and the pressure 152 multiplied by a factor. The pressure 150 and the pressure 152 may be combined in any manner to provide the pressure 154 to properly position the pad 134 with respect to the rotor 138 while the brakes are not applied and while the brakes are applied.

In another example embodiment, the pressure combiner 116 does not receive brake fluid from the master cylinder 122 or the pad positioner 114 but has its own reservoir of brake fluid. The pressure combiner 116 detects the pressure 150, detects the pressure 152 and provides brake fluid via the conduit 154 at the combined (e.g., calculated) pressure 154. As the pressure 150 and/or the pressure 152 varies, the combined pressure 154 also varies. In this example embodiment, the master cylinder 122 may be a closed system with respect to its own brake fluid and the pad positioner 114 may be a closed system with respect to its own brake fluid so that brake fluid from the master cylinder 122 and brake fluid from the pad positioner 114 do not physically combine (e.g., mix) to provide brake fluid to the brake piston 132, but the brake fluid provided to the brake piston 132 is provided by the reservoir of the pressure combiner 116.

In another example embodiment, the pressure combiner 116 does not receive brake fluid from the pad positioner 114. The pressure combiner 116 detects the pressure 152, and increases the pressure of the brake fluid provided by the master cylinder 122 by the amount of the pressure 152 before providing the brake fluid from the master cylinder 122 to the brake piston 132 via the conduit 154.

In another example embodiment, the pressure combiner 116 does not receive brake fluid from the master cylinder 122. The pressure combiner 116 detects the pressure 150, and increases the pressure of the brake fluid provided by the pad positioner 114 by the amount of the pressure 150 before providing the brake fluid to the brake piston 132 via the conduit 154.

In another example embodiment, the master cylinder 122, the pad positioner 114 and the brake piston 132 do not utilize brake fluid to operate. The master cylinder 122 reports an amount of pressure the driver applies to the pedal 124. The pressure is reported to the pressure combiner 116 as pressure 150. The pad positioner 114 reports an earlier determined pressure, the pressure 152, for positioning the pad 134 relative to the rotor 138 while the brakes are not applied. The pressure combiner 116 determines an output pressure, the pressure 154. The output pressure 154 is determined as discussed above (e.g., sum, adjusted, sum*factor). As a pedal 124 is pressed or released, the pressure 150 varies, therefore, the pressure 154 also varies. The pressure 154 is reported to the brake piston 132. The brake piston 132 translates the pressure 154 into a distance between the pad 134 and the rotor 138 or an amount of force to be applied by the pad 134 to the rotor 138.

In an example embodiment, when the brakes are not applied, the master cylinder 122 reports the pressure 150 as the non-braking pressure 650 and the pad positioner 114 provides the pressure 152 that represents a base pressure. The base pressure sets the position of the pad 134 relative to the rotor 138. The pressure combiner 116 combines the non-braking pressure 650 with the base pressure to position the friction material 252 a short distance away from the face 254 of the rotor 138. A short distance means that the friction material 252 does not touch or lightly (e.g., barely) touches the face 254 of the rotor 138.

When the driver presses the pedal 124, the pressure 150 from the master cylinder 122 increases from the non-braking pressure 650 to a braking pressure, which is greater than the non-braking pressure 650. The braking pressure may vary (e.g., increase, decrease), but it is greater than the non-braking pressure. The pressure combiner 116 combines the braking pressure with the base pressure to press the friction material 252 of the pad 134 against the rotor 138 to slow the rotation of the rotor 138. The amount of force applied to the pad 134 to force the friction material 252 against the rotor 138 is proportional to the braking pressure.

When the driver stops pressing on the pedal 124, the pressure 150 from the master cylinder 122 decreases from the braking pressure to the non-braking pressure 650. As a result, the pressure from the pressure combiner 116 decreases to the combination of the non-braking pressure 650 and the base pressure from the pad positioner 114. As the braking pressure decreases, the friction material 252 moves away from the rotor 138 to the position where the friction material 252 is the short distance away or barely touching the rotor 138 as discussed above.

### Pressure Sensor

The pressure sensor 118 is adapted to detect an amount of pressure. The pressure sensor 118 is adapted to report the amount of pressure it detects. The pressure sensor 118 may report the amount of the detected pressure as an analog value and/or a digital value. In an example embodiment, this the pressure sensor 118 detects the amount of the pressure 154. The pressure sensor 118 reports the pressure to the processing circuit 110.

In an example embodiment, the pressure sensor 118 is adapted to detect when the friction material 252 of the pad 134 comes into contact with the face 254 of the rotor 138.

When the pressure sensor 118 reports contact between the friction material 252 and the face 254 of the rotor 138, the distance Dpfrf 260 is equal to zero whereas the pad thickness 270 of the friction material 252 is the distance Dprf 220. While the friction material 252 contacts the rotor 138, the processing circuit 110 may request the pad position detector 136 to determine the distance Dprc 230 and/or the distance Dprf 220. The distance Dprc 230 at the point of contact of the friction material 252 with the face 254 may be used to determine the thickness of the friction material 252 as discussed below. The distance Dprf 220 represents the pad thickness 270 of the friction material 252 as discussed above.

### Processing Circuit and Memory

The processing circuit 110 may be any type of system or circuit that performs the functions of the processing circuit 110. An example embodiment of the processing circuit 110 includes a microprocessor, a signal processor, a computer, and/or any combination thereof. The processing circuit 110 may receive signals (e.g., analog, digital) and/or data, for example, the data from the pressure sensor 118, the pad positioner 114 and/or from the pad position detector 136. The processing circuit 110 may generate signals and/or data for controlling other components, such as the pad positioner 114 and/or the pressure combiner 116. The processing circuit 110 may use data received from the pressure sensor 118 and/or the pad position detector 136 to determine the signals and/or the data for controlling the pad positioner 114 and/or the pressure combiner 116.

The processing circuit 110 may further detect temperature. In an example embodiment, temperature sensors are positioned in different physical positions on the braking system 100. The temperature sensors may report their detected temperatures to the processing circuit 110. In another embodiment, the temperature sensors are integrated into the processing circuit 110. The processing circuit 110 may detect the temperature of the braking system 100 and/or the temperature of the atmosphere that surrounds the braking system 100. The processing circuit 110 may adjust the signals and/or data that controls other components in accordance with the temperature detected.

The memory 112 may be any type of suitable memory. The memory 112 may include volatile (e.g., DRAM, SRAM, flash) and non-volatile memory (e.g., ROM, flash, EPROM, PROM, EEPROM). The memory 112 may include a drive (e.g., magnetic, solid-state, optical).

The processing circuit 110 may access the memory 112. The processing circuit 110 may store data in (e.g., write data to) the memory 112. The processing circuit 110 may receive (e.g., read) data from the memory 112. The memory 112 may store a program. The processing circuit 110 may execute the stored program to perform the functions of the braking system 100. The memory 112 may be integrated into the processing circuit 110.

In an example embodiment, the processing circuit 110 receives information from the pressure sensor 118 and the pad position detector 136. The processing circuit 110 uses the information to determine an acceptable position of the pad 134 with respect to the rotor 138. The processing circuit 110 may also receive information from the pressure combiner 116 and/or the pad positioner 114. The processing circuit may also control, in whole or in part, the pressure combiner 116 and/or the pad positioner 114. The processing circuit 110 may aid the pad positioner 114 in determining the pressure 152 to position the pad 134 a small distance away from the rotor 138 while the brakes are not applied. The processing circuit 110 may determine and/or control how the pressure combiner 116 combines the pressure 150 and the pressure 152 to provide the pressure 154. The processing circuit 110 may determine the non-braking pressure 650. The processing circuit 110 may adjust the pressure 152 remove the non-braking pressure 650. The processing circuit 110 may sum the pressure 150 and the pressure 152.

The processing circuit 110 may multiply the sum by a factor. The processing circuit 110 may store information in the memory 112 that may be used to perform its functions. The processing circuit 110 may store a history of the pad thickness 270 in memory 112.

### Calibration of Pad Position

The processing circuit 110, the pad positioner 114, the pressure combiner 116, the pressure sensor 118 and the pad position detector 136 may cooperate with each other to calibrate the braking system 100. Calibrating the braking system 100 refers to positioning the pad 134 a specific distance away from the rotor 138 to provide a reasonable braking response time and to reduce the amount of drag of the pad 134 on the rotor 138 to an acceptable level. In an example embodiment, an acceptable level of braking response time means a human driver cannot detect (e.g., perceive) a delay between the application of the force on the pedal 124 and the application of the brakes. Another way to determine an acceptable level of braking response is the distance the pedal 124 must be moved before the brakes are applied. Preferably, the brakes are applied when the pedal 124 is depressed a short distance (e.g., ¼″-4″).

Force An acceptable level of the reduction in the amount of drag means that while the force is not applied on the brake pedal 124, the interaction of the pad 134 with the rotor 138 does not slow the velocity of the vehicle while the vehicle is coasting (e.g., power from engine not applied, in neutral). In other words, the drag of the pad on the rotor does not noticeably affect, from the perspective of the driver, the velocity of the vehicle. Another way to determine an acceptable level of drag is whether the drag of the pad 134 on the rotor 138, while the brakes are not applied, affects fuel economy.

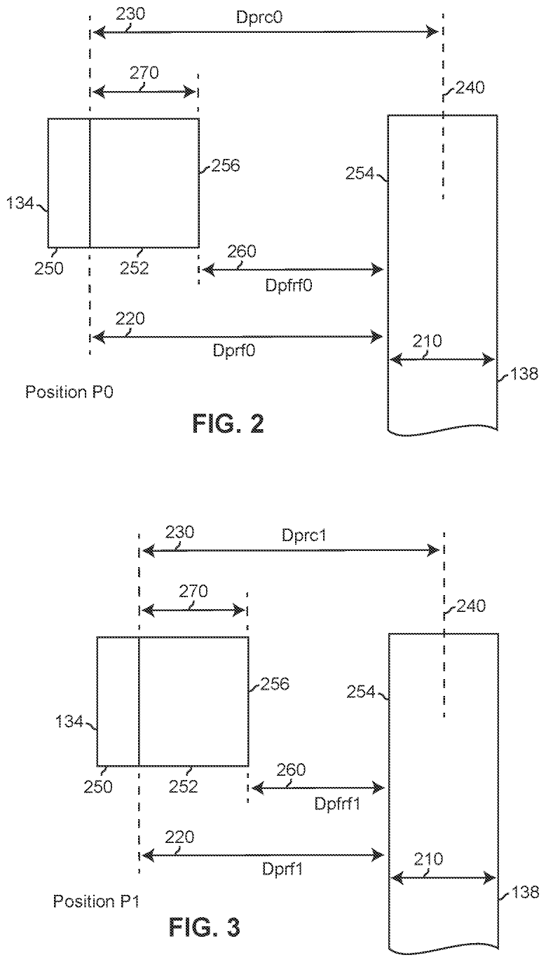

In the FIGS. 2-5, the distance between the pad 134 and the rotor 138 is shown for four different positions, P0-P3, of the pad 134 with respect to the rotor 138. The size of the pad 134, the distance Dprc 230, the distance Dprf 220, the distance Dpfrf 260, pad thickness 270, rotor thickness 210 and the size (e.g., height) of the rotor 138 as shown in FIGS. 2-5 are not to scale. The distance Dprc 230 is measured from the center 240 of the rotor 138 to the front of the backing plate 250 on the pad 134. The distance Dprf 220 is measured from the front of the backing plate 250 to the face 254 of the rotor 138. The distance Dpfrf 260 is measured from the face 256 of the friction material 252 to the face 254 of the rotor 138.

In FIG. 2, the position P0 is illustrated. While the pad 134 is positioned at the position P0, the distance Dprc 230 is equal to Dprc0, the distance Dprf 220 is equal to Dprf0 and the distance Dpfrf 260 is Dpfrf0. While the pad 134 is positioned at the position P0, the friction material 252 is so far away from the face 254 of the rotor 138 that there is a noticeable delay between pressing on the pedal 124 and the application of the brakes because the pad 134 must travel the distance Dpfrf0 before it comes into contact with the rotor 138. While the pad 134 is positioned at position P0, the friction material 252 of the pad 134 is so far away from the face 254 of the rotor 138 that there is no contact and therefore no drag between the pad 134 and the rotor 138. So, the position P0 produces no drag, but provides a poor braking response time.

In FIG. 3, the position P1 is illustrated. While the pad 134 is positioned at the position P1, the distance Dprc 230 is equal to Dprc1, the distance Dprf 220 is equal to Dprf1 in the distance Dpfrf 260 is Dpfrf1. Dprc1 is less than Dprc0, Dprf1 is less than Dprf0 and Dpfrf1 is less than Dpfrf0. While the pad 134 is positioned at the position P1, the friction material 252 is so far away from the face 254 of the rotor 138 that there is still an unacceptable amount of delay between pressing on the pedal 124 and the application of the brakes because the pad 134 must travel the distance Dpfrf1 before it comes into contact with the rotor 138. While the pad 134 is at position P1, the friction material 252 of the pad 134 is so far away from the face 254 of the rotor 138 that there is no drag between the pad 134 and the rotor 138. So, the position P1 produces no drag, but still provides a poor braking response time.

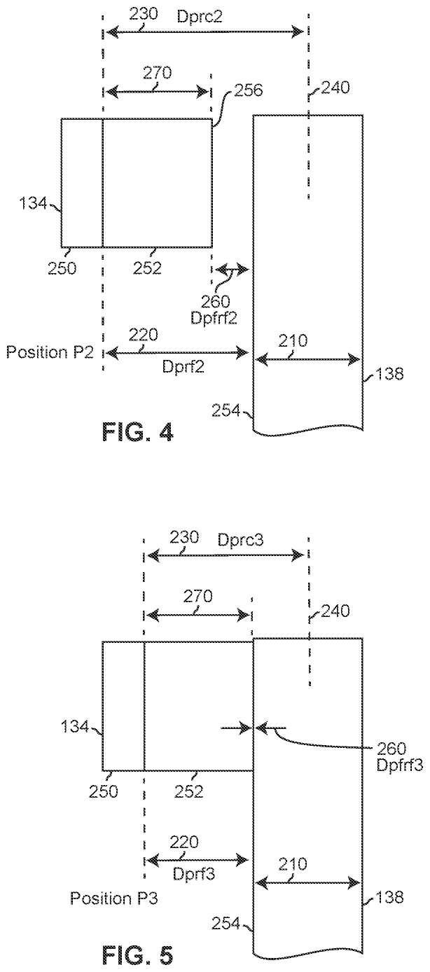

In FIG. 4, the position P2 is illustrated. While the pad 134 is positioned at the position P2, the distance Dprc 230 is equal to Dprc2, the distance Dprf 220 is equal to Dprf2 and the distance Dpfrf 260 is Dpfrf2. Dprc2 is less than Dprc1, Dprf2 is less than Dprf1 and Dpfrf2 is less than Dpfrf1. While the pad 134 is positioned at the position P2, the friction material 252 is positioned a small distance away from (e.g., Dpfrf 260 is small, 0.1 mm-5 mm) or lightly touches the face 254 of the rotor 138 (e.g, Dpfrf 260 essentially zero). Because the distance between the friction material 252 is a small distance or is only lightly touching, there is little drag and may provide an acceptable amount of delay between pressing on the pedal 124 and the application of the brakes. While the pad 134 is positioned in the position P2, the pad need only traverse the distance Dpfrf2 to applied the brakes. The position P2 may be a desirable (e.g., suitable, acceptable) position for the pad 134 because it offers a reasonable braking response time and little or no drag.

In FIG. 5, the position P3 is illustrated. While the pad 134 is positioned at the position P3, the distance Dprc 230 is equal to Dprc3, the distance Dprf 220 is equal to Dprf3 and the distance Dpfrf 260 is Dpfrf3. If Dpfrf2 is greater than zero, Dprc3 is less than Dprc2, Dprf3 is less than Dprf2 and Dpfrf3 is less than Dpfrf2. If Dpfrf2 is essentially zero so that the friction material 252 lightly touches the face 254 of the pad 138, then Dpfrf3 likely equal to Dpfrf2, but Dprc3 and Dprf3 may be slightly less than Dprc2 and Dprf2 respectively as the pad 134 is forcefully pressed against the rotor 138, especially if the friction material 252 is compressible.

In FIG. 5, the face 256 of the friction material 252 is shown to be in contact with the face 254 of the rotor 138. Above with respect to FIG. 4, the friction material 252 is described as being positioned close to or lightly touching the face 254 of the rotor 138. In position P3, the friction material 252 more than lightly touches the rotor 138. In position P3, the pad 134 presses on the rotor 138. At position P3, the pressure of pad 134 against the rotor 138 is less than the force applied when the pedal 124 is pressed, but it is more than the pressure applied by the pad 134 while positioned at position P2. The pressure applied by the pad 132 against the rotor 138 in position P3 is sufficient to slow the velocity the car when coasting, therefore, the position P3 is not acceptable with respect to the drag of the pad 134 against the rotor 138. The position P3 offers excellent braking response times because the friction material 252 is already in contact with the face 254 of the rotor 138, so when the pedal 124 is pressed, the pad 134 need not travel any distance before coming in contact with the rotor 138. Upon pressing the pedal 124, the amount of time to applying the brakes is near zero. However, from the perspective of drag, position P3 has little to offer. So, the position P3 offers excellent response time, but results in too much drag.

A review of the advantages and disadvantages of the positions P0-P3 tends to show that the position P2 may offer a reasonable braking response time and a reasonable amount of drag. So, it appears desirable to position the pad 134 at the position P2 so that the pad 134 is positioned the distance Dprc2 away from the rotor 138. Preferably, the pad 134 should be position at the position P2 while the brakes are not being applied. Applying the brakes will move the pad 134 across the distance Dpfrf2 to bring the friction material 252 into forceful contact with face 254 of the rotor 138. Increasing the force applied to the pedal 124 will increase the force of the friction material 252 against the face 254 of the rotor 138, thereby causing greater deceleration in the rotation of the rotor 138. After braking has ended, or another words when the force on the pedal 124 has been released, the pad 134 will move back to the position P2.

In accordance with the above, it is desirable to position the pad 134 in the position P2 while the brakes are not applied. The pad 134 will not assume the position P2 without intervention. A resilient force is applied to the pad 134 to move (e.g., push) it away from the face 254 of the rotor 138 while the brakes are not applied. The resilient force moves the pad 134 away from the rotor 138 to reduce drag; however, the resilient force, in most braking systems, is not adjustable, so it likely moves the pad 134 as far away from the rotor 138 as it a can. To move the pad 134 to the position P2, the resilient force must be overcome. Further, as the friction material 252 wears away with use, the position of the pad 134 with respect to the rotor 138 may need to be recalibrated to find a new position that offers reasonable braking response time and reasonable drag.

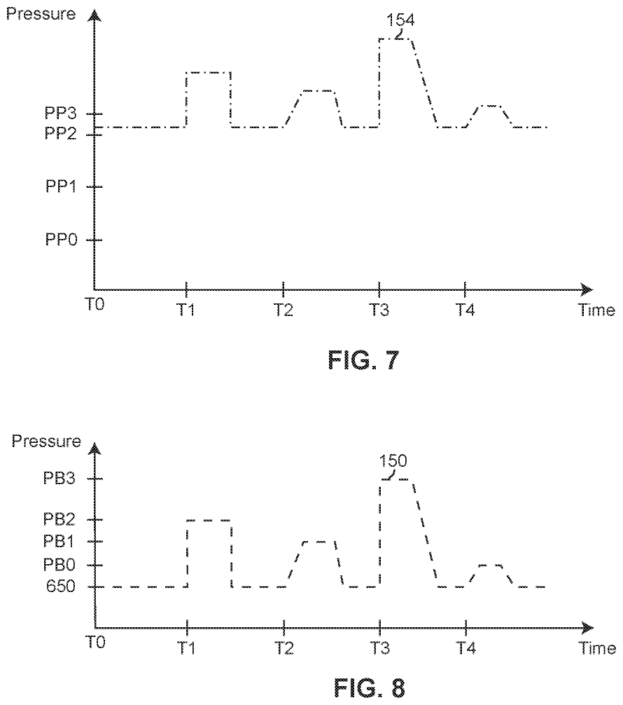

The pad positioner 114 is used to position the pad 134 at the position identified during calibration as an acceptable position, which in this example is the position P2. As discussed above, the pressure combiner 116 receives the pressure 150 from the master cylinder 122. While the brakes are not applied, the master cylinder 122 provides the non-braking pressure 650. The non-braking pressure is constant as long as the pedal 124 is not pressed. The non-braking pressure 650 is shown in FIGS. 6 and 7. The pressure combiner 116 detects the non-braking pressure 650 via the conduit 150 while the brakes are not applied.

When the brakes are applied by applying a force to (e.g., pressing on) the pedal 124, the pressure 150 from the master cylinder 122 increases. In an example embodiment, the pressure 150 increases proportionally to the force applied to the pedal 124. When the force is removed from the pedal 124, the pressure 150 from the master cylinder 122 decreases until it reaches the non-braking pressure 650.

As discussed above, in an example embodiment, the output of the pressure combiner 116 is brake fluid provided at the pressure 154. In an example embodiment, the pressure combiner 116 takes the pressure 150 from the master cylinder 122 combines it with the pressure 152 from the pad positioner 114 and provides the brake fluid via the conduit 154 at the pressure 154. In the example embodiment shown in FIG. 6, during calibration the pressure from the master cylinder 122 is fixed at the non-braking pressure 650. So, the pressure 154 from the pressure combiner 116 is the pressure 152 combined with the non-braking pressure 650. The output pressure, pressure 154, of the pressure combiner 116 is shown as the dot-dash line in FIG. 6.

The information shown in FIG. 6 relates to the example embodiment of the pressure combiner 116 that sums the pressure 150 and the pressure 152 to provide the output pressure 154. As shown on the y-axis of the graph in FIG. 6, the pressure 152 ranges from 0 (e.g., PSI) to the pressure PP3. While the pressure 152 from the pad positioner 114 is at zero, the pressure 154 is equal to zero plus the non-braking pressure 650. So, while the pressure 152 is zero and the brakes are not applied, the pressure applied to the brake piston 132 is the non-braking pressure 650 which positions the pad 134 in a position to the left of the position PO as shown in FIG. 2.

When the pressure 152 from the pad positioner 114 is increased from zero to PPO, the output pressure 154, while brakes are not applied, is PP0 plus the non-braking pressure 650, which is sufficient to move the pad 134 to the P0 position as shown in FIG. 2.

When the pressure 152 is increased from PP0 to PP1, the output pressure 154 from the pressure combiner 116, while the brakes are not applied, is PP1 plus the non-braking pressure 650, which is sufficient to move the pad 134 to the P1 position as shown in FIG. 3.

When the pad positioner 114 increases the pressure 152 from PP1 to PP2, the output pressure 154 from the pressure combiner 116, while the brakes are not applied, is PP2 plus the non-braking pressure 650, which is sufficient to move the pad 134 to the P2 position as shown in FIG. 4. As discussed above, the P2 position provides an acceptable braking response time and an acceptable amount of drag.

If the pad positioner 114 increases the pressure 152 from PP2 to PP3, the output pressure 154 from the pressure combiner, while the brakes are not applied, is PP3 plus the non-braking pressure 650, which is sufficient to move the pad 134 to the P3 position as shown in FIG. 5. As discussed above, the P3 position brings the friction material 252 into pressing contact with face 254, which provides a good response time but an unacceptable amount of drag. As the pad 134 is further pressed against the rotor 138, the pressure 154 increases rapidly because the friction material 252 is in pressing (e.g., forceful) contact with the face 254 and the brake fluid is incompressible. The pressure sensor 118 is adapted to monitor the pressure 154. When the pressure 154 increases rapidly and significantly, the pressure sensor 118 reports that the pad 134 is in pressing contact with rotor 138. If the pad positioner 114 were to increase the pressure 152 to be greater than the pressure PP3, the output pressure 154 from the pressure combiner 116 would continue to increase rapidly and significantly, as shown in FIG. 6. Before the pressure from the pad positioner 114 reaches pressure PP3, the pad 134 was not in contact with or was in light touching contact with the rotor 138, so the pressure from the pad positioner 114 merely move the pad 134 closer to the rotor 138. But once the pad 134 more than lightly touches the rotor 138, the pressure 154 rises rapidly because pad 134 is being forced against the rotor 138. So, the pressure sensor 118 can detect when the pad 134 more than lightly touches the rotor 138.

During the calibration process, the position of the pad 134 and the pressure provided by the pad positioner 114 may be calibrated by decreasing the pressure 152 down from PP3 to PP2, so the pad 134 is positioned in the P2 position while the master cylinder 122 provides the pressure 150 at the non-braking pressure 650. The processing circuit 110 records the pressure 152 of PP2 as being the pressure that provides a suitable position for the operation of the braking system 100. After calibration, the pad positioner 114 maintains the pressure 152 at the pressure PP2 during operation of the braking system 100. The pressure 154 provided by the pressure combiner 116 to position the brake pad 134 at an acceptable position is determined by calibration. Calibration may also be referred to as the calibration process which is performed while the brakes are not applied.

When processing circuit 110 detects, via the pressure sensor 118, the point just before the rapid and significant increase in the pressure 154, the processing circuit 110 can request the pad position detector 136 to measure and report the position of the pad. While the friction material 252 is in contact with face 254 of the rotor 138 (e.g., position P3), the processing circuit 110 knows that the distance Dpfrf 260 is zero. The processing circuit 110 may record the distance Dprc 230 and/or Dprf 220. Using Dprc 230 and Dprf 220, the processing circuit 110 is able to calculate the pad thickness 270 of the friction material 252 of the pad 134 as being:

Pad Thickness 270=Dprc 230−(Rotor Thickness 210/2); (1)

or

Pad Thickness 270=Dprf 220 (2)

When the pad 134 is not touching the rotor 138, the processing circuit 110 may calculate the thickness of the friction material 252 as being:

Pad Thickness 270=Dprc 230−(Dpfrf 260+(Rotor Thickness 210/2)); (3)

or

Pad Thickness 270=Dprc 230−(Dpfrf 260+(Dprc 230−Dprf 220)) (4)

If the pad position detector 136 can detect values for Dprc 230 and Dpfrf 260, or Dprf 220, Dprc 230 and Dpfrf 260 at any time during operation of the braking system 100, then the processing circuit 110 can determine the thickness 270 of the friction material 252 at any time.

As the thickness of the friction material 252 decreases through use, the acceptable position for providing reasonable response time and reasonable drag changes, so from time to time, the processing circuit 110 recalibrates the braking system 100 to determine a new acceptable position for the pad 134, as discussed above.

Once the braking system 100 has been calibrated and an acceptable position for the pad 134 determined, the pad positioner 114 maintains the pressure 152 at the pressure required to move and retain the pad 134 at the acceptable position, which in the example provided above is the position P2 and the pressure PP2.

### In Operation

During normal operation of the braking system 100, the pad positioner 114 sets the pressure 152 to the pressure determined during calibration (e.g., pressure PP2). The pressure PP2 from the pad positioner 114 is combined with the non-braking pressure 650 from the master cylinder 122 to position the pad 134 at the position P2 while the brakes are not applied. During normal operation, the pad positioner 114 maintains the pressure 152 at the pressure PP2. The pressure 152 acts as a base pressure so the minimum value for the pressure 152 is the pressure PP2 combined with the non-braking pressure 650. Each time the driver presses the pedal 124, the pressure 152 is combined with pressure 150 from the master cylinder 122, which increases the pressure 154 above the non-braking pressure 650 plus the pressure PP2.

The example of combining the pressure 150 and the pressure 152 shown in FIG. 7, uses summing to combine the pressures. Between the time T0 and T1, the driver does not press on the brake pedal 124. The pressure 150 from the master cylinder 122 is the non-braking pressure 650. The pressure 152 from the pad positioner 114 is PP2, which is sufficient to move the pad 134 to position P2 as discussed above. At the time T1, driver abruptly presses on the pedal. The pressure 150 (dashed line) from the master cylinder 122 increases from the non-braking pressure 650 to a higher pressure.

The braking pressure from the master cylinder 122 varies with the force (e.g., pressure) applied to the pedal 124. As the pressure 150 increases, the pressure 154 also increases. The increase in the pressure 154 moves the pad 134 into forceful contact with the rotor 138 to slow the rotation of the rotor 138.

The driver abruptly releases the pedal sometime after the time T1, so the pressure 150 decreases back to the non-braking pressure 650, so the pressure 154 returns to the pressure PP2 plus the non-braking pressure 650. At the time T2, the driver slowly presses the pedal 124 to brake the vehicle. The pressure 150 slowly increases from the non-braking pressure 650 to an intermediate braking pressure. The pressure 154 increases accordingly. The driver holds the pedal 124 for a while then releases it so the pressure 150 returns to the non-braking pressure 650. The pressure 154 decreases accordingly. At the time T3, the driver slams on the brakes, so the pressure 150 rapidly increases from the non-braking pressure 650 to a high braking pressure. The pressure 154 also rises quickly and significantly thereby bringing the friction material 252 into hard and forceful contact with the face 254 of the rotor 138. After forcefully pressing on the pedal 124 for a period of time, the driver slowly releases the pedal so that the pressure 150 slowly returns to the non-braking pressure 650. The pressure 154 accordingly slowly returns to the pressure PP2 plus the non-braking pressure 650. At the time T4, the driver lightly and briefly taps the pedal 124 so that the pressure 150, and correspondingly the pressure 154, rise slightly, and briefly above the non-braking pressure 650.

As is evident in FIG. 7, in normal operation, the pad positioner 114 provides the base pressure 152 to the pressure combiner 116. The pressure 150 from the master cylinder 122 determines the combined output pressure 154. The pad positioner 114 provides sufficient pressure to position the pad 134 in the desired position (e.g., position P2) for reasonable braking response time and reasonable drag. Each time the pedal 124 is pressed, the pad 134 moves from the position P2 into forceful contact with the rotor 138.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A braking system for a vehicle, the braking system comprising
a rotor;
a pad, a resilient force positioned the pad a first distance away from a face of the rotor;
a master cylinder adapted to report a first pressure, the first pressure proportional to a force applied to a brake pedal;
a pad positioner adapted to report a second pressure, the second pressure adapted to overcome the resilient force to position the pad a second distance away from the face of the rotor, the second distance less than or equal to the first distance;
a pressure combiner adapted combine the first pressure and the second pressure to provide a brake fluid at a third pressure; wherein:
while the force is not applied to the brake pedal, the third pressure positions the pad the second distance away from the face of the rotor; and
while the force is applied to the brake pedal, the third pressure positions the pad against the face of the rotor to slow a rotation of the rotor.

2. The braking system of claim 1 wherein the pad positioner determines the second pressure through a calibration process.

3. The braking system of claim 1 wherein the second distance provides a braking response time that cannot be detected by a human driver.

4. The braking system of claim 1 wherein the second distance provides and amount of drag that does not slow a velocity of the vehicle whether the vehicle is coasting.

5. The braking system of claim 1 wherein the pressure combiner combines the first pressure and the second pressure by adding the first pressure to the second pressure.

6. The braking system of claim 1 wherein the pressure combiner combines the first pressure and the second pressure by multiplying a sum of the first pressure and the second pressure by a factor.

7. The braking system of claim 1 wherein while the force is not applied to the brake pedal, the first pressure is equal to a non-braking pressure.

8. The braking system of claim 1 wherein while the force is not applied to the brake pedal, the third pressure positions the pad the second distance away from the face of the rotor whereby the pad does not contact the rotor.

9. The braking system of claim 1 wherein while the force is applied to the brake pedal, the third pressure proportional to the force.

10. A braking system for a vehicle, the braking system comprising
a pressure combiner adapted to combine a first pressure and a second pressure to provide a third pressure, the first pressure proportional to a force applied to a brake pedal, the second pressure adapted to position a pad a first distance away from a face of a rotor; wherein:
while the force is not applied to the brake pedal, the third pressure positions the pad the first distance away from the face of the rotor; and
while the force is applied to the brake pedal, the third pressure positions the pad against the face of the rotor to slow a rotation of the rotor.

11. The braking system of claim 10 wherein the pressure combiner is further adapted to:
receive a first brake fluid at the first pressure;
receive a second brake fluid at the second pressure; and
provide at least one of the first brake fluid and the second brake fluid at the third pressure.

12. The braking system of claim 10 wherein a driver of the vehicle provides the force on the brake pedal to slow movement of the vehicle.

13. The braking system of claim 10 wherein the third pressure is a sum of the first pressure and the second pressure.

14. The braking system of claim 10 wherein the third pressure is a sum of the first pressure and the second pressure multiplied by a factor.

15. The braking system of claim 10 wherein while the force is not applied to the brake pedal, the third pressure is equal to a non-braking pressure.

16. The braking system of claim 10 wherein while the force is applied to the brake pedal, the third pressure proportional to the force.

17. The braking system of claim 10 wherein the second pressure is determined using a calibration process.

18. A braking system for a vehicle, the braking system comprising
a pad positioner adapted to report a first pressure, the first pressure for positioning a pad a first distance away from a face of a rotor;
a pressure combiner adapted to combine the first pressure and a second pressure to provide a third pressure, the second pressure proportional to a force applied to a brake pedal; wherein:
while the force is not applied to the brake pedal, the third pressure positions the pad the first distance away from the face of the rotor; and
while the force is applied to the brake pedal, the third pressure positions the pad against the face of the rotor to slow a rotation of the rotor.

19. The braking system of claim 18 wherein the first pressure is determined using a calibration process.

20. The braking system of claim 18 wherein the third pressure is a sum of the first pressure and the second pressure.
